(19) United States
(12) Patent Application Publication
(10) Pub. No.: US 2006/0129368 A1
(43) Pub. Date: Jun. 15, 2006

(54) Object-oriented interface to RTL model signals

(76) Inventors: Zachary Steven Smith, Fort Collins, CO (US); John Warren Maly, Laporte, CO (US); Ryan Clarence Thompson, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/011,409

(22) Filed: Dec. 14, 2004

(51) Int. Cl. G06F 17/50

(52) U.S. Cl. 703/14

(57) ABSTRACT

Systems, methodologies, media, and other embodiments associated with an object-oriented interface to register transfer language (RTL) signals are described. One exemplary system embodiment includes logic for acquiring the address of an RTL signal and for providing method level access to the RTL signal. The exemplary system embodiment may also include an object that facilitates establishing a relationship between the RTL signal address and RTL signal name and thus facilitates providing method level access to the RTL signal.

### BACKGROUND

Integrated circuits like microprocessors are frequently modeled before fabrication. For example, a processor may be modeled using a register transfer language (RTL) model. An RTL model may include, for example, logic and signals. The logic may correspond to devices like AND gates, OR gates, XOR gates, and so on, that may be fabricated into the integrated circuit. The signals may correspond to wires, traces, pins, and so on that may be fabricated into the integrated circuit. The signals in an RTL model may be associated with data structures that can vary in size, layout, content, and so on from signal to signal.

Accessing an RTL signal may involve reading from and/or writing to a data structure associated with the RTL signal. Conventionally, RTL signals were accessed by pointers. For example a C language program could be written to access an RTL signal through a depiper interface. Using a pointer provided by the depiper interface, data values in memory locations associated with an RTL signal could be accessed. For example, using a procedure like:
Unsigned*v=Install(signal_name);

a program could acquire a pointer to the first word in an RTL signal. However, the program (or programmer) would be responsible for obtaining, maintaining, and manipulating data associated with the signal. By way of illustration, since the data associated with RTL signals may have different sizes and layouts, a programmer would be responsible for knowing the size and layout of the data associated with each RTL signal accessed. Additionally, since one conventional interface provides a pointer to the first word of an RTL signal and no methods for processing the data associated with the RTL signal, the programmer would be responsible for coding methods for performing desired actions. For example, if an RTL signal included ten single bit fields, each of which represented whether a certain state existed in a processor, then if a programmer wanted to display the state information in a more human readable manner than a string of 1s and 0s, the programmer would be responsible for coding a print routine armed solely with a pointer to the first word of the RTL signal. Similarly, if a programmer wanted to compare signals, the programmer would be responsible for writing comparison code. This required programmers to acquire a bit-level knowledge of RTL signals and their associated data structures before attempting to address higher level concerns like processor verification using RTL signals.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a conventional depiper interface to an RTL model of a processor.

FIG. 2 illustrates an example object-oriented interface to an RTL model of a processor.

FIG. 3 illustrates an example class definition for an object associated with accessing an RTL signal.

FIG. 4 illustrates an example lockstep checker implemented in association with an object-oriented interface to an RTL model of a processor.

FIG. 5 illustrates an example black box modeled in RTL and an associated synthesized operation performed in association with an object-oriented interface to an RTL model.

FIG. 6 illustrates an example method for accessing an RTL model signal using an object-oriented interface.

FIG. 7 illustrates an example method for accessing RTL model signals using an object-oriented interface.

FIG. 8 illustrates an example computing environment in which example systems and methods illustrated herein may operate.

FIG. 9 illustrates an example object model.

### DETAILED DESCRIPTION

Example systems and methods described herein concern an object model for accessing RTL signals through a depiper interface. The example object model facilitates associating an object with an RTL signal and then accessing the RTL signal using data and methods provided by the object. In one example, the object model allows accessing RTL signals by name, rather than through a pointer, which elevates the degree of abstraction with which RTL signals can be processed. The object model may include class definitions that facilitate associating methods with RTL signals and thus making RTL signals appear to have more intelligence and self-awareness than is provided through a simple conventional pointer. The methods may include, for example, methods for accessing and establishing a relationship with an RTL signal via, for example, a key/value pair, methods for retrieving values associated with an RTL signal, methods for comparing an RTL signal to a value, methods for printing an RTL signal value, and so on. Thus, a programmer may be freed from acquiring low level (e.g., bit level) knowledge of an RTL signal and may be able to operate at a higher logical level on the RTL signal. Operating at a higher logical level may be facilitated by having objects maintain knowledge about RTL signal size, value, location, layout, comparison methods, and so on.

RTL signals may be interesting to examine singly. But sets of RTL signals may be even more interesting to examine. For example, sixteen related RTL signals may represent an address and thirty-two other related RTL signals may represent a value associated with that address. Thus, in one example, the object model provides a higher level container framework for accessing and/or processing sets of RTL signals. The higher level container framework may facilitate, for example, iterating through a set of RTL signals, comparing one set of RTL signals to another set, performing logical operations on sets of RTL signals, and so on. In one example, a signal map facilitates conceptually grouping RTL signals and performing synthesized logic operations on selected members of the set.

Some integrated circuits may include multiple cores on a single chip. One application for multiple cores on a single chip is to provide a lockstep mode that facilitates assessing system reliability. Thus, one application built using the example object model is a microarchitectural lockstep checker. A lockstep checker may reside in and/or be associated with a depiper. The lockstep checker may employ the example object model, and thus indirectly the depiper interface, to monitor selected RTL signals in an RTL processor model that models an integrated circuit with dual cores. This may facilitate determining, for example, whether the dual cores are synchronized during a simulation. Analyzing the modeling results of dual cores operating in lockstep mode may facilitate detecting a failure in a core. Analyzing the modeling results of three or more cores operating in lockstep mode may facilitate not only detecting but also potentially correcting a failure in a core. Thus, a tangible, concrete, real-world result associated with an example object model includes producing a model of a lockstep checker employed in processor model verification.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

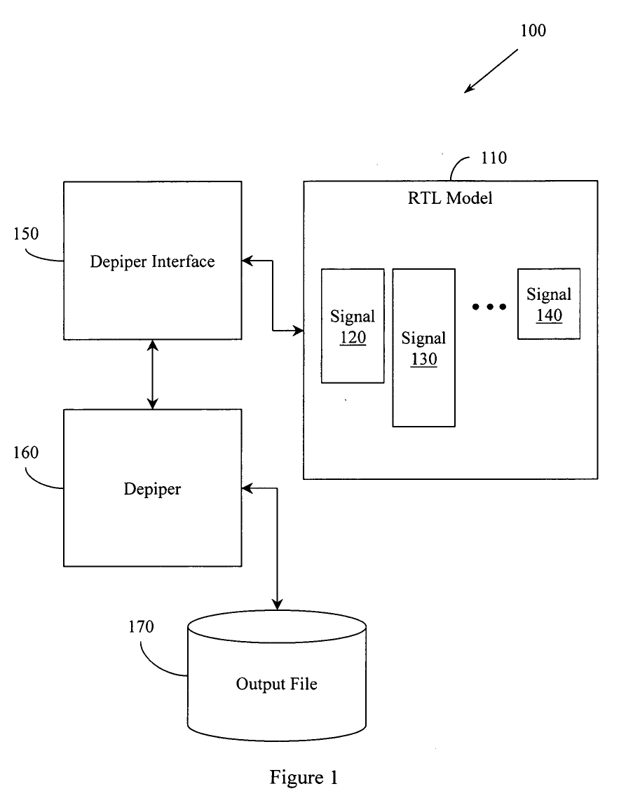

FIG. 1 illustrates a system 100 that includes an RTL model 110 of a processor. The RTL model 110 may include several signals (e.g., signal 120, signal 130, . . . , signal 140) that model wires, lines, traces, pins, and so on that may be fabricated into an integrated circuit. RTL signals may be associated with data structures that store information about the RTL signal. Various RTL signals may have data structures that differ in layout, size, content, location, and so on.

System 100 also illustrates a conventional depiper interface 150 to the RTL model 110. Conventionally, the depiper interface 150 could provide an application like depiper 160 with a pointer to an RTL signal. For example, the depiper interface 150 may provide a pointer to the first word of a data structure associated with an RTL signal. Then, applications like depiper 160 would be responsible for navigating through the RTL signal, which would require the application to have bit-level knowledge of the RTL signal. Since RTL signals may vary in layout, size, location, and so on, applications like depiper 160 could be difficult to write. Furthermore, one change in a signal could require numerous changes in an application like depiper 160. While depiper interface 150 is illustrated separate from depiper 160, it is to be appreciated that in some examples the depiper interface 150 and depiper 160 or other similar applications may be more tightly coupled.

Depiper 160 may be, for example, a logic that monitors nodes and signals in an RTL model of a processor design. In one example, depiper 160 may be software that contains specific analyzers and checkers like a lockstep checker. The depiper 160 may analyze complex sets and/or series of RTL signal combinations to provide information about conceptual events like whether a certain instruction has retired from a processor. While signal retirement is described, it is to be appreciated that other conceptual events like interrupts occurring, data cache misses occurring, and so on may be analyzed. Information about conceptual events may be consumed by other (micro)architectural checkers. In one example, depiper 160 may write information about these conceptual events to a data store like an output file 170. While a file 170 is illustrated, it is to be appreciated that depiper 160 may provide the information about conceptual events to other locations like memories, displays, and so on.

The specific analyzers and checkers in a depiper may require access to RTL model signals. Typically this access was a pointer-based access, which made crafting analyzers and checkers at times an excruciating process. An example object-oriented interface to RTL signals facilitates analyzer and checker programmers having a higher-level access to RTL signals.

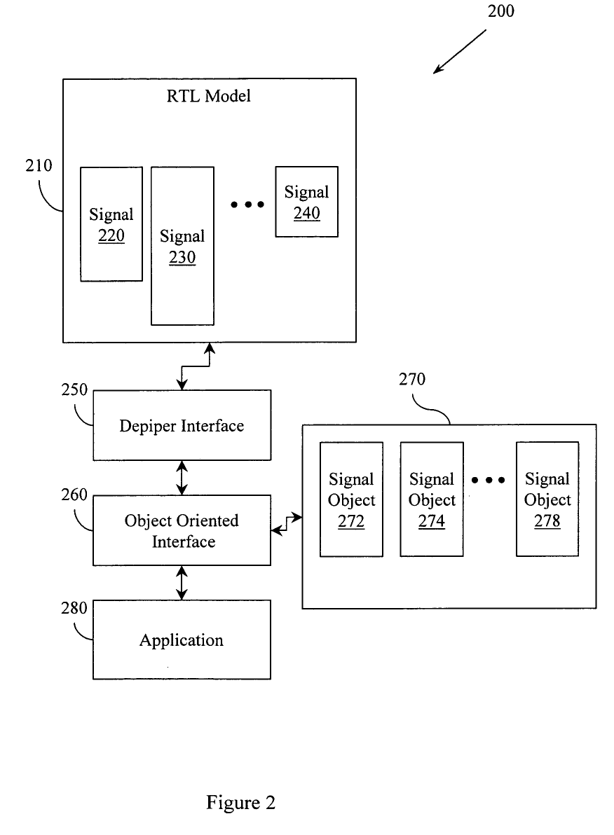

Thus, FIG. 2 illustrates a system 200 that includes an example object-oriented interface 260 to RTL model signals (e.g., 220 through 240). System 200 may include and/or interact with an RTL model 210. The RTL model 210 may include RTL signals like signals 220 through 240. It is to be appreciated that an RTL model may include a large number of RTL signals (e.g., 20,000). The RTL signals may store information in bits, bit fields, bytes, words, and so on. Furthermore, different RTL signals may store different amounts and/or types of data and may have different sizes, layouts, locations, and so on.

System 200 may include a depiper interface 250 that is configured to provide a pointer to the first word of an RTL signal. System 200 may also include an object oriented interface 260 that is configured to make a higher level abstraction of an RTL signal available to a downstream consumer like application 280. The object oriented interface 260 may include and/or be associated with a data structure 270 that facilitates associating an instance of an object with an RTL signal. For example, signal object 272 may be associated with RTL signal 220, signal object 274 may be associated with RTL signal 230, and so on. In one example, signal objects may be mapped to RTL signals by name. For example, an RTL signal 220 may be named RegisterX_Trace_One. Depiper interface 250 may provide a pointer to the first word of that RTL signal to the object oriented interface 260. Then, the object oriented interface 260 may map the address in the pointer to a signal object using the name. Data structure 270 may facilitate establishing and/or maintaining that mapping. An application 280 may then access the RTL signal by name through a signal object provided by the object oriented interface 260. Thus, the object model, which may include the object oriented interface 260, the data structure 270, and an instance(s) of a signal object may be additional logics that may exist, for example, in a processor verification architecture. In one example, the object oriented interface 260 and the signal object(s) are implemented in software. The software may be coded, for example, in C++.

The object oriented interface 260 may reside logically in between depiper interface 250 and application 280. Thus, application 280 may be coded at a higher level of abstraction than a conventional application. Typically, application 280 would be required to manage RTL signals at a bit level. However, with object oriented interface 260, application 280 may interact with RTL signals at a higher level. For example, a signal object may implement methods that facilitate reading a data value associated with an RTL signal, writing a value to an RTL signal, printing a data value associated with an RTL signal, comparing the values of two RTL signals, and so on. Thus, application 280 may employ these methods to access and/or manipulate an RTL signal, without having the bit-level knowledge of the RTL signal. The bit level knowledge of the RTL signal, and intelligence for interacting with the RTL signal can be encapsulated in a signal object. Therefore application 280 may include code like:
Signal object Instance 1=access(RegisterX_Trace_One);
Instance1.print( );

rather than hundreds of lines of bit field manipulating code typically required to print the contents of an RTL signal.

Additionally, object oriented interface 260 may provide a container level framework for processing sets of RTL signals. The container level framework may facilitate, for example, iterating through a set of RTL signals, producing synthesized logic operations on sets and/or series of RTL signals, and so on.

In one example, system 200 may be a processor verification system that includes an RTL model logic (not illustrated) that is configured to provide an RTL model 210 of a processor. The RTL model 210 may include, for example, RTL signals (e.g., 220 through 240) and RTL logics (not illustrated). The system 200 may also include a depiper interface 250 that is operably connectable to the RTL model logic. The depiper interface 250 may be configured to provide access, via pointers, to RTL signals associated with RTL model 210. The system 200 may also include an object oriented RTL signal interface 260 that is operably connectable to the depiper interface 250. The object oriented RTL signal interface 260 may be configured to provide access, using a key(s) in a key/value mapping, to RTL signals (e.g., 220 through 240) in the RTL model 210 that are accessible via the depiper interface 250.

In one example, the object oriented RTL signal interface 260 may include class definitions for objects that are configured to facilitate accessing an RTL signal and that provide a semantic level interface to an RTL signal. Thus, the interface 260 may also include an instance(s) of an object(s) defined by the class definition. To facilitate creating and/or maintaining relationships between objects and signals, interface 260 may also include a map that is configured to store, in a key/value mapping data store, key/value pairs that represent mappings between instances objects and RTL signals.

In one example, the class definitions may describe programmatically accessible methods configured to access an RTL signal. The methods may include, for example, a read method, a write method, a print method, a compare method, and so on. Similarly, the class definitions may describe data fields that are configured to store information concerning an RTL signal. The data fields may include, for example, a pointer field configured to store the address of an RTL signal, a name field configured to store the name of an RTL signal, a length field configured to store the length of an RTL signal, a count field configured to store a count of the number of fields in an RTL signal, and so on. While four methods and four data fields are described it is to be appreciated that a greater and/or lesser number of methods and/or data fields may be employed.

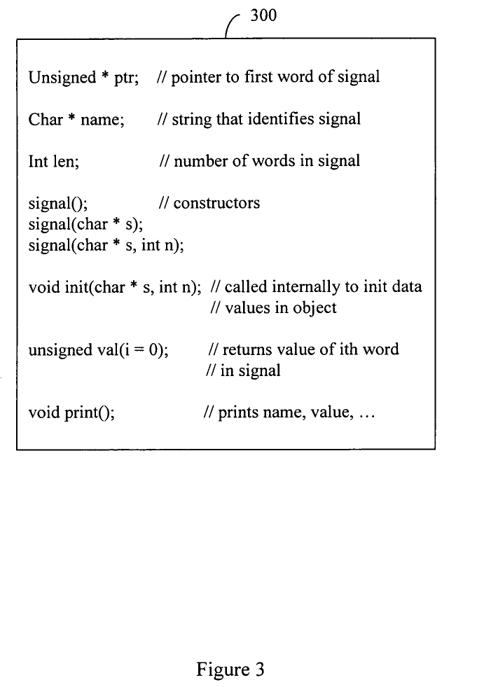

FIG. 3 illustrates an example class definition 300 associated with an object for accessing an RTL signal. The class definition 300 may include various data and methods that facilitate providing a higher level abstraction of an RTL signal than is typically provided by a pointer based depiper interface. The data may include, for example, a pointer to the first word of a signal. The value for this pointer may be provided by a conventional pointer based depiper interface. The data may also include, for example, a string for storing the name of the RTL signal whose first word address is stored in the pointer. The data may also include, for example, a length field that stores the number of words in the signal with which the object is associated. While a pointer, a name, and a length are described, it is to be appreciated that other objects may include a greater and/or lesser number of data fields that store similar and/or additional information.

The methods may include, for example, a set of constructors that are called when an instance of the class is constructed. Various constructors with different parameter lists may be provided due to the polymorphic nature of object oriented systems. The methods may include, for example, an initialization method that may be employed during class construction to establish various data values in the instance of the object. The methods may also include methods that encapsulate the bit level knowledge of the RTL signal. For example, a method val( ) may be provided that returns the value of a specified word in an object. The method val( ) may be, for example, a hidden method that provides functionality for a visible method like print( ). A programmer or application may use the print( ) method to view, in human readable form, the contents of an RTL signal. The print( ) method may encapsulate knowledge about the number of words in a signal, their layout, and their meaning. Thus, the print( ) method may use the val( ) method to retrieve the value of various words in the signal that are to be printed. While constructors, initialization methods, hidden methods like val( ) and visible methods like print( ) are illustrated, it is to be appreciated that other classes may include other methods.

One example object may be an LSNode class object associated with a lockstep checker. The lockstep checker may use instances of the LSNode class to access various RTL signals related to lockstep checking. A lockstep checker is a specific microarchitectural checker that may logically reside inside a depiper. The lockstep checker may take advantage of the infrastructure of the depiper to read signals out of an RTL model. When an object oriented interface is available, a lockstep checker may be crafted at a higher level, using for example, LSNode class objects to read the signals out of the RTL model.

As mentioned above, objects may be aggregated together by a container object. One example container object may be established for blocks of signals like blocks of input signals, blocks of output signals, blocks of state signals, and so on. The block classes may inherit from a class like a BaseStruct class. The BaseStruct class may include methods like:
V(char*nm, int I=0);
Print( );
Add(char*cp, int n=1);
Check(char*nm, unsigned*v);
And data like
NodeMap s;

The v( ) method may, for example, return the i^{th} data word from an RTL signal by first looking up s[nm] and then returning s[nm]->val(i). S is a map of signal names and may include key/value pairs whose key is a signal name and whose value is the address of the first word of the signal.

The check( ) method may, for example, input the name of a signal to check and a pointer to the first word of an array of computed values to check against the actual value. This may facilitate, for example, comparing RTL signals and/or portions thereof. For example, the check( ) method may perform a key/value lookup and compare values.

While four methods and one data entry are described, it is to be appreciated that container classes may include a greater and/or lesser number of methods and/or data fields, and that the methods and/or data fields may have different types and/or perform different functions.

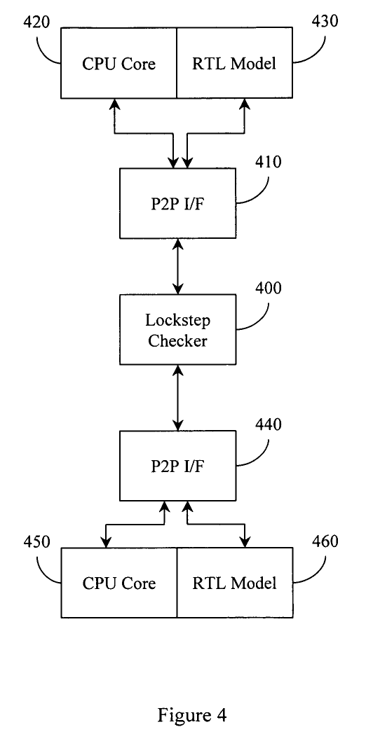

FIG. 4 illustrates an example lockstep checker 400 employing an object-oriented interface to an RTL model of a processor. Integrated circuits may have more than one core on a die. The cores may be connected by a logical bus interface. In a processor with two cores, the cores may operate independently like they would in a conventional multiprocessor system. In some examples, the cores may also be configured to operate in a lockstep mode, where the two cores execute the same instruction stream with the same data at the same time. Since core behavior is deterministic, the two cores should produce the same results. This should hold both in silicon and in RTL. The results may be propagated through a system using traces, lines, wires, pins, and so on. Thus, the results may be available on RTL signals.

In FIG. 4, a lockstep checker 400 has been built using an object interface that facilitates accessing RTL model signals. The lockstep checker 400 may reside logically between a first RTL model 430 that models a first core 420 and a second RTL model 460 that models a second core 450. The models may be operably connected to the lockstep checker by, for example, point-to-point (P2P) interface 410 and P2P interface 440. While a P2P interface is illustrated, it is to be appreciated that other connections like a front-side bus may be made. Conventionally, the lockstep checker 400 would need bit-level knowledge of the RTL signals associated with the cores. By using the object oriented interface to RTL signals, the lockstep checker 400 may be freed from these bit level concerns and thus coded at a higher level of abstraction.

As described above, some processors may have dual cores. These dual cores may be configured to run in a lockstep mode. Thus, in one example, a first RTL model 430 may be configured to model a first core 420 on an integrated circuit and a second RTL model 460 may be configured to model a second core 450 on an integrated circuit. The dual cores may be configured to selectively operate in a lockstep mode. While two RTL models (430, 460) are illustrated, it is to be appreciated that a single RTL model (e.g., 210, FIG. 2) may model dual cores. Thus, an object oriented RTL signal interface 260 (FIG. 2) may be configured to provide objects for a lockstep checker 400.

Lockstep checker 400 may be configured determine whether a first processor core 420 and a second processor core 450 are synchronized, or whether a simulation of first processor core 420 and second processor core 450 are synchronized. Lockstep checker 400 may be configured to selectively control a core and/or an RTL model to take actions when an out of synchronization condition is detected. For example, lockstep checker 400 may perform actions like turning off a failed core, disabling a data comparison between a first processor core and a second processor core, generating a restart alert that is configured to publish that a failed core is out of synchronization, preventing the propagation of data from a failed core into an RTL model, and so on.

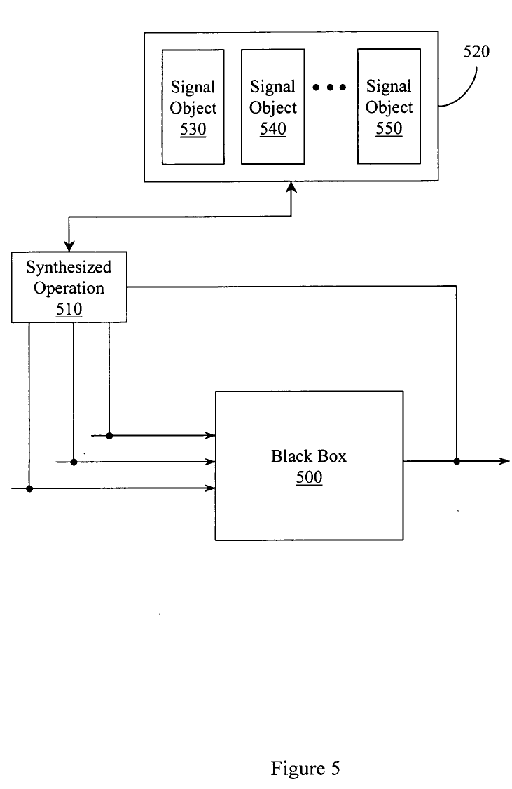

FIG. 5 illustrates a black box 500 that has been modeled in RTL and a synthesized operation logic 510. The synthesized operation logic 510 may be configured to perform an operation that relies on an object-oriented interface to an RTL model of a processor. The inputs to black box 500 and the output from black box 500 may be the inputs to the operation performed by synthesized operation logic 510. These inputs and outputs may be available as RTL signals in an RTL model of the black box 500. Thus, a container object 520 (e.g., C++ STL class object), may logically relate signal objects associated with the inputs and outputs. For example, signal objects 530 through 550 may be associated with the inputs and outputs to black box 500. Therefore, the synthesized operation logic 510 may take advantage of operations available through the container object 520. These operations may include, for example, iterating over a set of objects, concatenating values from a series of objects, selecting the greatest value from a set of objects, and performing logic operations on sets of operations. For example, black box 500 may be intended to implement a three-way AND of the inputs. Therefore, the synthesized operation logic 510 may report on the accuracy of the operation of black box 500 by performing the three way AND of the inputs and comparing it to the output of black box 500. While a three way AND is described, it is to be appreciated that this is but one example of an operation that may be performed in a synthesized operation logic 510 in conjunction with objects associated with RTL signals.

Applications (e.g., application 280, FIG. 2, lockstep checker 400, FIG. 4), may process signals singly and/or collectively. To facilitate collective analysis, an object oriented interface (e.g., 260, FIG. 2), may include a container framework 520 that is configured to facilitate collectively accessing a selected group of objects (e.g., 530 through 550) in a map accessible via key/value pairs. In one example, collectively accessing a selected group of objects in a map accessible via key/value pairs may include programming synthesized operation logic 510. The operation (e.g., a logic operation) performed by the synthesized operation logic 510 may concern selected members of a group of objects.

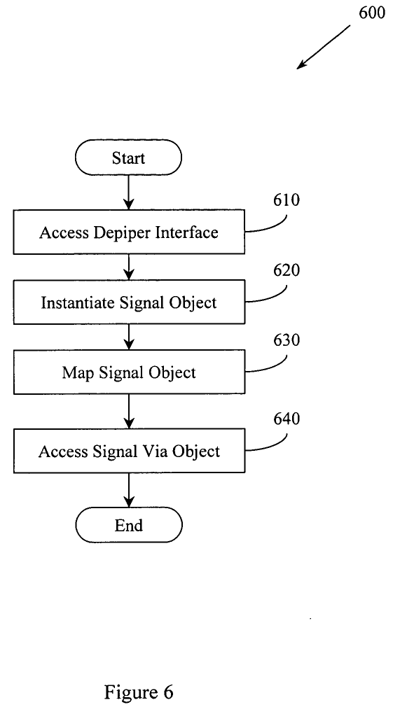

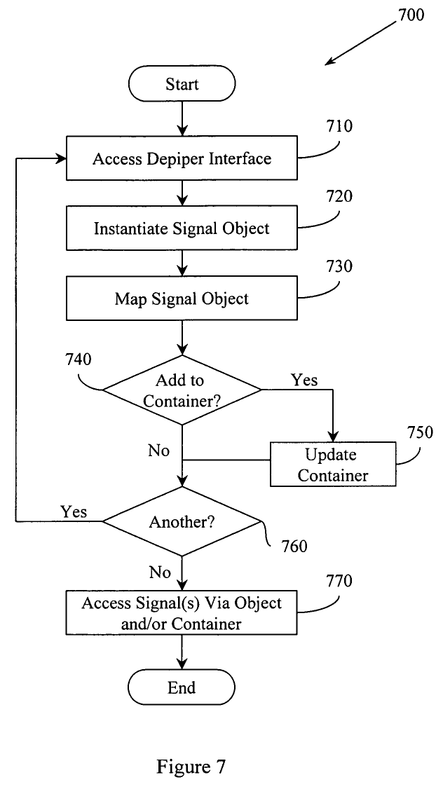

Example methods may be better appreciated with reference to the flow diagrams of FIGS. 6 and 7. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagram, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 6 illustrates an example processor executable method 600 for accessing an RTL model signal using an object-oriented interface. Method 600 may include, at 610, accessing a depiper interface to acquire an address of an RTL signal associated with an RTL model. In one example, accessing a depiper interface to acquire the address of an RTL signal may include calling a depiper interface procedure that installs an RTL signal in an RTL model. Accessing the depiper interface may also include retrieving the address of the first word of the installed RTL signal. The address may be, for example, the address of the first word of a data structure used to model the RTL signal.

Method 600 may also include, at 620, instantiating an object configured to provide a method level access to the RTL signal. As used herein, method level access refers to being able to request that an action be performed on and/or in association with an RTL signal where the RTL signal may be identified by name, rather than by a pointer address. This method level access contrasts with conventional pointer-oriented access to a method. Additionally, method level access refers to a program employing a method provided by an object, where the object maintains low level intelligence about an RTL signal. In one example, instantiating an object configured to provide method level access to the RTL signal includes actions like identifying an RTL signal type, acquiring bit level information about the RTL signal type, and so on. The bit level information may describe, for example, the order of various bitfields, the length of a bitfield, the number of words used to store a variable, and so on.

Method 600 may also include, at 630, mapping an object to an RTL signal. The mapping may include relating the address of the RTL signal and a programmatically accessible name of the RTL signal. In one example, mapping an object to an RTL signal may include establishing a key/value pair with the name of the RTL signal as the key and the address of the RTL signal as the value. The key/value pair may be stored, for example, in a C++ STL class object.

Method 600 may also include, at 640, accessing an RTL signal at a method level using the name of the RTL signal to identify the object to perform the method. In one example, accessing an RTL signal at a method level includes calling a method like a print method, a read method, a write method, and so on. The methods may be available through the object mapped to the RTL signal name.

While FIG. 6 illustrates various actions occurring in serial, it is to be appreciated that various actions illustrated in FIG. 6 could occur substantially in parallel. By way of illustration, a first process could instantiate signal objects, a second process could map signal objects, and a third process could provide access to signals via the signal objects instantiated by the first process and mapped by the second process. While three processes are described, it is to be appreciated that a greater and/or lesser number of processes could be employed and that lightweight processes, regular processes, threads, and other approaches could be employed.

FIG. 7 illustrates a processor executable method 700 for accessing RTL model signals using an object-oriented interface. Like method 600 (FIG. 6), method 700 includes actions like accessing 710 a depiper interface, instantiating 720 a signal object, and mapping 730 a signal object. At 740, a decision may be made concerning whether to add a mapped signal object to a container that facilitates relating groups of signal objects. Thus, method 700 may include, at 750, selectively adding a reference to a signal object to a container object. The referenced object may be configured to provide method level access to an RTL signal. The container may include methods that facilitate performing an operation on an aggregation of objects. Therefore, the container object operations may include, for example, iterating over an aggregation of objects, comparing two or more objects, producing a synthesized logic function involving two or more objects, and so on.

At 760, a determination may be made concerning whether there is another object to instantiate, map, and potentially add to the container. If the determination is Yes, then processing may return to 710. But if the determination is No, then processing may proceed to 770. At 770, signals may be accessed. In one example, aggregations of signals may be accessed using the container populated at 750. In another example, individual signals may be accessed using individual objects.

In one example, methodologies are implemented as processor executable instructions and/or operations stored on a computer-readable medium. Thus, in one example, a computer-readable medium may store processor executable instructions operable to perform a method that includes accessing a depiper interface to acquire an address of an RTL signal that is associated with an RTL model and instantiating an object configured to provide method level access to the RTL signal. The method may also include mapping an object to an RTL signal using an RTL signal address and a programmatically accessible RTL signal name. After the mapping, the method may include accessing an RTL signal at a method level employing the RTL signal name to identify an object to perform the method. While the above method is described being stored on a computer-readable medium, it is to be appreciated that other example methods described herein may also be stored on a computer-readable medium.

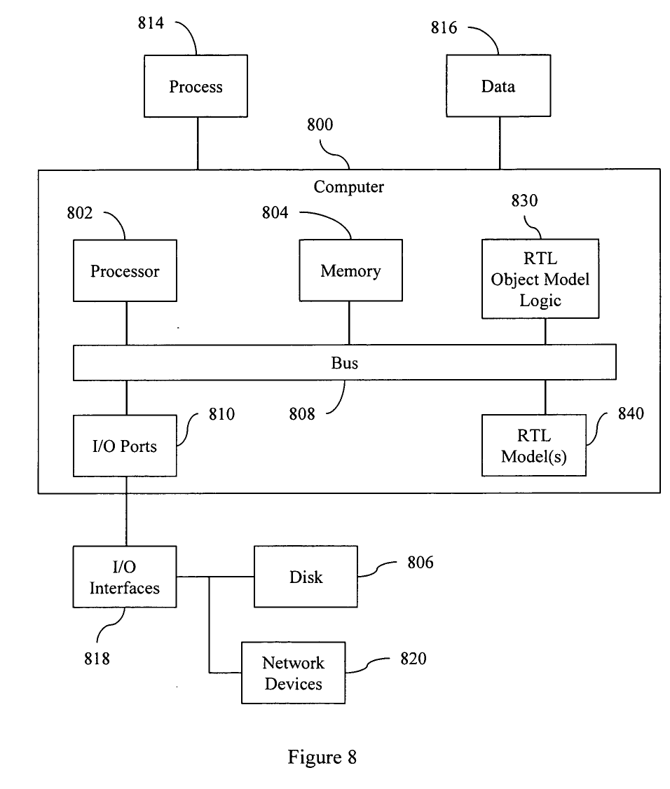

FIG. 8 illustrates a computer 800 that includes a processor 802, a memory 804, and input/output ports 810 operably connected by a bus 808. In one example, the computer 800 may also include an RTL object model logic 830 that is configured to facilitate accessing signals in an RTL model 840. The RTL object model logic 830 may, for example, provide means for acquiring the address of the first word of an RTL signal in RTL model 840. The RTL object model logic 830 may also include, for example, means for producing a key/value pair mapping between signal address and RTL signal names. Additionally, the RTL object model logic 830 may provide means for accessing an RTL signal in RTL model 840 using an instance of an object related to the signal by the key/value pair mapping. While the RTL object model logic 830 and the RTL model 840 are illustrated being connected to bus 808, it is to be appreciated that the logic 830 and the model 840 may be operably connected by other paths, apparatus, and so on.

The processor 802 can be a variety of various processors including dual microprocessor and other multi-processor architectures. The memory 804 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the computer 800 via, for example, an input/output interface (e.g., card, device) 818 and an input/output port 810. The disk 806 can include, but is not limited to, devices like a magnetic disk drive, a solid state disk drive, a floppy disk drive, a tape drive, a Zip drive, a flash memory card, and/or a memory stick. Furthermore, the disk 806 can include optical drives like a CD-ROM, a CD recordable drive (CD-R drive), a CD rewriteable drive (CD-RW drive), and/or a digital video ROM drive (DVD ROM). The memory 804 can store processes 814 and/or data 816, for example. The disk 806 and/or memory 804 can store an operating system that controls and allocates resources of the computer 800.

The bus 808 can be a single internal bus interconnect architecture and/or other bus or mesh architectures. While a single bus is illustrated, it is to be appreciated that computer 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 800 may interact with input/output devices via i/o interfaces 818 and input/output ports 810. Input/output devices can include, but are not limited to, a keyboard, a microphone, a pointing and selection device, cameras, video cards, displays, disk 806, network devices 820, and the like. The input/output ports 810 can include but are not limited to, serial ports, parallel ports, and USB ports.

The computer 800 can operate in a network environment and thus may be connected to network devices 820 via the i/o devices 818, and/or the i/o ports 810. Through the network devices 820, the computer 800 may interact with a network. Through the network, the computer 800 may be logically connected to remote computers. The networks with which the computer 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 820 can connect to WAN technologies including, but not limited to, point to point links, circuit switching networks like integrated services digital networks (ISDN), packet switching networks, and digital subscriber lines (DSL).

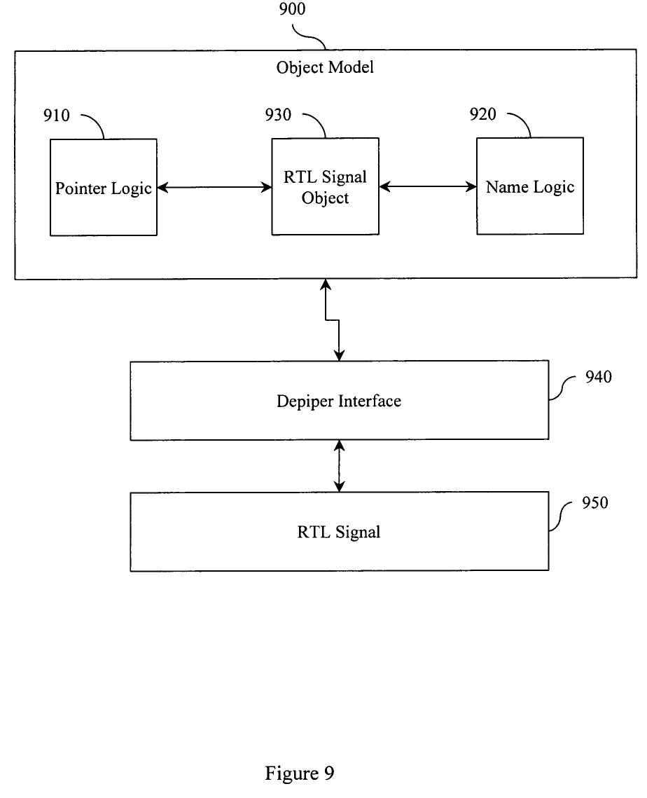

FIG. 9 illustrates an example object model 900. The object model 900 may be configured to provide a method level access to an RTL signal 950. The object model 900 may include a pointer logic 910 that is configured to acquire the address of RTL signal 950 using a depiper interface 940 that is operably connectable to an RTL model. The object model 900 may also include a name logic 920 that is configured to provide, via a name, a semantic level access to RTL signal 950. Semantic level access is contrasted with bit level access. In bit level access, a program or programmer was required to know, for example, the size in bits of a bit field and the order of various biffields. Then, the programmer would be required to perform bit level operations (e.g., clean, set, shift, rotate) on the bit fields. Semantic level access provides access to a bitfield by its name as a higher level item like a variable, where the intelligence concerning the size, layout, content, and so on of the bitfield, the so-called bit level information, is maintained in an object.

Object model 900 may also include an RTL signal object 930 that is operably connectable to pointer logic 910 and name logic 920. The RTL signal object 930 may be configured to establish a relationship between the RTL signal 950 name and the RTL signal 950 address. Additionally, the RTL signal object 930 may include methods for providing method level access to RTL signal 950. The methods may include, for example, a read method, a write method, a print method, a compare method, and so on.

The RTL signal object 930 may also include a data field(s) that is configured to store information concerning the RTL signal. The data fields may include, for example, a pointer field that is configured to store an RTL signal address, a name field configured to store an RTL signal name, a length field configured to store an RTL signal length (e.g., number of bits, number of words), a count field configured to store a count of the number of fields in an RTL signal, and the like.

Object model 900 may also include a data store (not illustrated) that is configured to store mappings between RTL signal names and RTL signal addresses. In one example, the object model 900 may also include a container object (not illustrated) that is configured to contain and relate one or more RTL signal objects. The container object may be, for example, a C++ STL class object.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. An object model configured to provide a method level access to a register transfer language (RTL) signal, comprising:
a pointer logic configured to acquire an address of the RTL signal using a depiper interface operably connectable to an RTL model;
a name logic configured to provide, via a name, a semantic level access to an RTL signal; and
an RTL signal object operably connectable to the pointer logic and the name logic, the RTL signal object being configured to establish a relationship between the name and the address, the RTL signal object comprising one or more methods for providing the method level access to the RTL signal.

2. The object model of claim 1, the methods comprising one or more of, a read method, a write method, a print method, and a compare method.

3. The object model of claim 1, the RTL signal object comprising one or more data fields configured to store information concerning the RTL signal, the one or more data fields comprising one or more of, a pointer field configured to store an RTL signal address, a name field configured to store an RTL signal name, a length field configured to store an RTL signal length, and a count field configured to store a count of the number of fields in an RTL signal.

4. The object model of claim 1, comprising a data store configured to store one or more mappings between one or more RTL signal names and one or more RTL signal addresses.

5. The object model of claim 4, comprising a container object configured to contain and relate one or more RTL signal objects.

6. The object model of claim 5, the container object comprising a C++ STL class object.

7. An object model configured to provide a method level access to a register transfer language (RTL) signal, comprising:
a pointer logic configured to acquire an address of the RTL signal using a depiper interface operably connectable to an RTL model;
a name logic configured to provide, via a name, a semantic level access to an RTL signal;
an RTL signal object operably connectable to the pointer logic and the name logic, the RTL signal object being configured to establish a relationship between the name and the address, the RTL signal object comprising one or more methods for providing the method level access to the RTL signal, the one or more methods comprising one or more of, a read method, a write method, a print method, and a compare method, the RTL signal object comprising one or more data fields configured to store information concerning the RTL signal, the one or more data fields comprising one or more of, a pointer field configured to store an RTL signal address, a name field configured to store an RTL signal name, a length field configured to store an RTL signal length, and a count field configured to store a count of the number of fields in an RTL signal; and
a data store configured to store one or more mappings between one or more RTL signal names and one or more RTL signal addresses; and a container object configured to contain and relate one or more RTL signal objects, the container object comprising a C++ STL class object.

8. A processor verification system, comprising:
a register transfer language (RTL) model logic configured to provide an RTL model of a processor, the RTL model including one or more RTL signals and one or more RTL logics;
a depiper interface operably connectable to the RTL model logic, the depiper interface being configured to provide access, via one or more pointers, to one or more RTL signals provided by the RTL model; and
an object oriented RTL signal interface operably connectable to the depiper interface, the object oriented RTL signal interface being configured to provide access, using one or more keys in a key/value mapping, to one or more RTL signals provided by the RTL model that are accessible via the depiper interface.

9. The processor verification system of claim 8, the object oriented RTL signal interface comprising:
one or more class definitions of objects configured to provide a semantic level interface to the RTL signal;
one or more instances of objects defined by the one or more class definitions; and
a map configured to store, in a key/value mapping data store, one or more key/value pairs representing one or more mappings between the one or more instances and one or more RTL signals.

10. The processor verification system of claim 9, the one or more class definitions describing one or more programmatically accessible methods configured to manipulate an RTL signal, the programmatically accessible methods comprising one or more of, a read method, a write method, a print method, and a compare method.

11. The processor verification system of claim 9, the one or more class definitions comprising one or more data fields configured to store information concerning an RTL signal, the one or more data fields comprising one or more of, a pointer field configured to store an RTL signal address, a name field configured to store an RTL signal name, a length field configured to store an RTL signal length, and a count field configured to store a count of the number of fields in an RTL signal.

12. The processor verification system of claim 9, the RTL model being configured to model an integrated circuit with dual cores configured to selectively operate in a lockstep mode.

13. The processor verification system of claim 12, the object oriented RTL signal interface being configured to provide one or more objects for a lockstep checker.

14. The processor verification system of claim 13, the lockstep checker being configured determine whether a first processor core simulation and a second processor core simulation are synchronized, and to selectively control the RTL model logic to perform one or more of, turning off a failed processor core simulation, disabling a data comparison between the first processor core simulation and the second processor core simulation, generating a restart alert configured to publish that a failed processor core simulation is out of synchronization, and preventing the propagation of data from a failed processor core simulation.

15. The processor verification system of claim 9, comprising:
a container framework configured to facilitate collectively accessing a selected group of objects in the map accessible via key/value pairs.

16. The processor verification system of claim 15, where collectively accessing a selected group of objects in the map accessible via key/value pairs includes programming a synthesized operation logic to perform one or more operations on one or more members of the selected group of objects.

17. A processor verification system, comprising:
a register transfer language (RTL) model logic configured to provide an RTL model of a processor, the RTL model including one or more RTL signals and one or more RTL logics;
a depiper interface operably connectable to the RTL model logic, the depiper interface being configured to provide access, via one or more pointers, to one or more RTL signals provided by the RTL model; and
an object oriented RTL signal interface operably connectable to the depiper interface, the object oriented RTL signal interface being configured to provide access, using one or more keys in a key/value mapping, to one or more RTL signals provided by the RTL model that are accessible via the depiper interface, the object oriented RTL signal interface comprising:
one or more class definitions of objects configured to provide a semantic level interface to the RTL signal, the one or more class definitions describing one or more programmatically accessible methods configured to manipulate an RTL signal, the one or more methods comprising one or more of, a read method, a write method, a print method, and a compare method, the one or more class definitions also comprising one or more data fields configured to store information concerning an RTL signal, the one or more data fields comprising one or more of, a pointer field configured to store an RTL signal address, a name field configured to store an RTL signal name, a length field configured to store an RTL signal length, and a count field configured to store a count of the number of fields in an RTL signal;
one or more instances of objects defined by the one or more class definitions; and
a map configured to store, in a key/value mapping data store, one or more key/value pairs representing one or more mappings between the one or more instances and one or more RTL signals.

18. A processor executable method, comprising:
accessing a depiper interface to acquire an address of an RTL signal in an RTL model;
instantiating an object configured to provide a method level access to the RTL signal;
mapping the object to the RTL signal using the address of the RTL signal and a programmatically accessible name of the RTL signal; and
accessing the RTL signal at a method level using the name of the RTL signal to identify the object to perform the method.

19. The method of claim 18, where accessing a depiper interface to acquire an address of an RTL signal in an RTL model comprises:
calling a depiper interface procedure configured to install an RTL signal; and
retrieving the address of the first word of the installed RTL signal.

20. The method of claim 18, where instantiating an object configured to provide a method level access to the RTL signal comprises:
identifying an RTL signal type; and
acquiring one or more bit level identifications associated with the RTL signal type.

21. The method of claim 18, where mapping the object to the RTL signal includes establishing a key/value pair with the name of the RTL signal as the key and the address of the RTL signal as the value, and where accessing the RTL signal at a method level includes calling one or more of, a print method, a read method, and a write method available in an object mapped to the RTL signal name.

22. The method of claim 18, comprising:
selectively adding to a container object a reference to the object configured to provide a method level access to the RTL signal, where the container object includes one or more methods that facilitate performing an operation on an aggregation of objects.

23. The method of claim 22, where the operation includes one or more of, iterating over an aggregation of objects, comparing two or more objects, and producing a synthesized logic function involving two or more objects.

24. The method of claim 23, the method being stored as a set of processor executable instructions stored on a computer-readable medium.

25. A processor executable method, comprising:
accessing a depiper interface to acquire an address of an RTL signal in an RTL model, where accessing the depiper interface comprises:
calling a depiper interface procedure configured to install an RTL signal; and
retrieving the address of the first word of the installed RTL signal;
instantiating an object configured to provide a method level access to the RTL signal, where instantiating the object comprises:
identifying an RTL signal type; and
acquiring one or more bit level identifications associated with the RTL signal type;
mapping the object to the RTL signal using the address of the RTL signal and a programmatically accessible name of the RTL signal, where mapping the object to the RTL signal includes establishing a key/value pair with the name of the RTL signal as the key and the address of the RTL signal as the value;
accessing the RTL signal at a method level using the name of the RTL signal to identify the object to perform the method, where accessing the RTL signal at a method level includes calling one or more of, a print method, a read method, and a write method available in an object mapped to the RTL signal name; and
selectively adding to a container object a reference to the object configured to provide a method level access to the RTL signal, where the container object includes one or more methods that facilitate performing an operation on an aggregation of objects, where the operation includes one or more of, iterating over an aggregation of objects, comparing two or more objects, and producing a synthesized logic function involving two or more objects.

26. A system, comprising:
means for acquiring the address of the first word of an RTL signal;
means for producing a key/value pair mapping between the address and the name of the RTL signal; and
means for accessing the RTL signal using an instance of an object related to the signal by the key/value pair mapping.
